(19) United States
(12) Patent Application Publication
(10) Pub. No.: US 2023/0335925 A1
(43) Pub. Date: Oct. 19, 2023

(54) COAXIAL CONNECTOR ASSEMBLY HAVING LOCKING FERRULE

(71) Applicant: CORNING OPTICAL COMMUNICATIONS RF LLC, Glendale, AZ (US)

(72) Inventors: Soren Baldus-Kunze, Slagelse (DK); Nikolaj Slobodziuk, Vordingborg (DK)

(21) Appl. No.: 18/211,960

(22) Filed: Jun. 20, 2023

Related U.S. Application Data
(63) Continuation of application No. PCT/US22/11842, filed on Jan. 10, 2022.
(60) Provisional application No. 63/135,560, filed on Jan. 8, 2021.

(51) Int. Cl. H01R 9/05

(52) U.S. Cl. CPC H01R 9/0518

(57) ABSTRACT

A connector assembly for attachment to a coaxial cable with an outer corrugated conductor having a peak and a plurality of valleys. The assembly includes an outer body (such as a back nut) for receiving the coaxial cable and a discrete ferrule separate from the outer body. The ferrule has a base and one or more elongated arms extending outward from the base. Each of said one or more elongated arms has an inward facing side with a ridge configured to engage a first valley to lock the coaxial cable to the outer body. The ferrule base forms a c-shaped ring with a gap. The c-shaped ring closes on the outer conductor to pinch the outer conductor between the gap. The ferrule also has a widened foot that engages a second valley to further lock the coaxial cable to the outer body.

### CROSS-REFERENCE TO RELATED APPLICATIONS

This application claims the benefit of priority of U.S. Application Nos. 63/135,560 filed Jan. 8, 2021, and International Application No. PCT/US22/11842, filed Jan. 10, 2022. The content of each aforementioned priority application is relied upon and incorporated herein by reference in its entirety.

### BACKGROUND

The present disclosure generally relates to coaxial connector assemblies, and particularly a coaxial connector assembly, having a locking ferrule.

A coaxial cable is characterized by having an inner electrical conductor, an outer electrical conductor, and a dielectric between the inner and outer electrical conductors. The inner electrical conductor may be hollow or solid. At the end of coaxial cable, a connector or connector assembly is attached to allow for mechanical and electrical coupling of the coaxial cable.

Connectors and connector assemblies for attachment to coaxial cables have been used throughout the coaxial cable industry for a number of years. One type of coaxial cable has an annularly corrugated outer conductor and a plain cylindrical inner conductor. Generally, connectors and connector assemblies that attach to these types of coaxial cables are different from those where the outer electrical conductors are smooth or uncorrugated.

For example, Patent EP332811 shows one connector assembly type which includes a single annular clamping portion that meshes with the last valley or outermost valley of the corrugated outer conductor, providing a single circumferential point of contact. Without additional axial reinforcement from the coaxial cable connector, physical gyrations of the cable found in field applications due to weather and vibration can cause undue stress and, ultimately, material fatigue of the corrugated cable outer conductor. The EP332811 patent is incorporated by reference in its entirety herein.

The aforementioned example clearly shows there is a continuing need for improved high-performance coaxial cable connectors and connector assemblies. There is a particular need for connectors and connector assemblies that can be installed and uninstalled easily and quickly, particularly under field conditions. Also, since these connectors and connector assemblies are generally installed in the field, they should be configured for pre-assembly, so that the possibility of dropping and losing small parts, misplacing o-rings, damaging or improperly lubricating o-ring, or other assembly errors in the field are minimized. Additionally, it should be possible for the coaxial cable connector to be installed and removed without the use of any special tools.

In view of the aforementioned needs, as well as other issues with prior connector and connector assembly designs, alternatives are desired.

### SUMMARY

In accordance with a first embodiment of the present disclosure, a connector assembly is provided for attachment to a corrugated coaxial cable, the corrugated coaxial cable has a center conductor, a dielectric surrounding the center conductor, and a corrugated outer conductor surrounding the dielectric. The connector assembly has a rearward outer body to be received over a portion of the corrugated coaxial cable, the rearward outer body having a recessed area. The connector assembly also has a locking ferrule to be partially inserted into the rearward outer body, the locking ferrule having a ridge configured for engagement with the corrugated outer conductor, and a foot portion positionable within the recessed area such that upon coupling of the rearward outer body with the locking ferrule, the corrugated outer conductor is locked in position.

In a second embodiment, the connector assembly of the first embodiment has a ferrule with a plurality of annular ridges and wherein at least one of the plurality of annular ridges engages a valley of the corrugated outer conductor. A third embodiment includes the connector assembly of the first or second embodiments, wherein the locking ferrule has a front ferrule end having an inwardly extending projection configured to engage with the post body. A fourth embodiment includes the connector assembly of the first through third embodiments, wherein the locking ferrule has a plurality of slots that facilitate spring-like engagement with the corrugated outer conductor upon assembly with the rearward outer body.

In a fifth embodiment, a method is provided of making a connector assembly to be attached to a corrugated coaxial cable, the corrugated coaxial cable having a center conductor, a dielectric surrounding the center conductor, and a corrugated outer conductor surrounding the dielectric. The includes forming a rearward outer body to be received over a prepared end of the corrugated coaxial cable, wherein the rearward outer body has a recessed area defined therein. The method also includes forming a locking ferrule to engage the rearward outer body, the locking ferrule having a ridge configured for engagement with the corrugated outer conductor, and a foot portion positionable within the recessed area. The method also includes coupling of the rearward outer body with the locking ferrule and locking the corrugated outer conductor in position.

In a sixth embodiment of the disclosure, a connector assembly is provided for attachment to a coaxial cable with an outer conductor having a peak and a valley. The connector assembly has an outer body for receiving the coaxial cable. The assembly also has a discrete ferrule separate from said outer body. The ferrule has a base and one or more elongated arms extending outward from the base. Each of the one or more elongated arms has an inward facing side with a ridge configured to engage the valley to lock the coaxial cable to the outer body. A seventh embodiment includes the connector assembly of the sixth embodiment, wherein the ferrule has a C-shaped ring with a gap at the base, the C-shaped ring closing on the outer conductor to pinch the outer conductor between the gap. An eighth embodiment includes the connector assembly of the sixth or seventh embodiments, wherein the outer body has an inner surface with a recess, each of the one or more elongated arms having a foot portion with a lip projecting outward from an outer surface of each of the one or more elongated arms, the lip configured to be received at the recess.

A ninth embodiment includes the connector assembly of the eighth embodiment, wherein the outer body has an inwardly-sloped inner surface, whereby the foot engages the inner surface of the outer body to bend each of the one or more elongated arms inwardly so that the ridge engages the cable valley and locks the ferrule to the cable. A tenth embodiment includes the connector assembly of the eighth embodiment, wherein the outer body has a step with a reduced diameter, whereby said foot engages the step to bend each of said one or more elongated arms inwardly so that the ridge engages the cable valley and locks the ferrule to the cable. An eleventh embodiment includes the connector assembly of any of the sixth through tenth embodiments, wherein the outer body has a ramp configured to engage the base to reduce a diameter of the base to pinch the outer conductor. A twelfth embodiment includes the connector assembly of any of the sixth through eleventh embodiments, wherein the base has a front base surface, and a post body is configured to engage the outer body, the post body having a rearward surface configured to mate with the front base surface of the ferrule to push the ferrule along a longitudinal axis of the assembly into the outer body as the outer body is further engaged with said post body.

A thirteenth embodiment includes the connector assembly of the twelfth embodiment, wherein the post body has external threads and the outer body has internal threads that threadably engages the post body external threads. A fourteenth embodiment includes the connector assembly of any of the sixth through twelfth embodiments, wherein the outer conductor has a first valley and a second valley, the discrete ferrule further having a widened foot configured to engage a first valley and the ridge configured to engage the second valley. A fifteenth embodiment includes the connector assembly of the fourteenth embodiments, wherein the ridge and the foot have a same shape as the first and second valley. A sixteenth embodiment includes the connector assembly of the fourteenth or fifteenth embodiments, wherein the ferrule has a first bend line, whereby the ferrule bends at the first bend line to engage the ridge with the first valley. A seventeenth embodiment includes the connector assembly of the sixteenth embodiment, wherein the ferrule has a second bend line, whereby the ferrule bends at the second bend line to engage the foot with the second valley.

An eighteenth embodiment includes the connector assembly for attachment to a coaxial cable with an outer conductor having a peak and a valley. The connector assembly includes an outer body for receiving the coaxial cable and having a compression mechanism. The connector assembly also includes a discrete ferrule separate from the outer body, the ferrule having a base forming an open ring with a gap, the compression mechanism compressing said open ring to close on the outer conductor under force applied by the compression mechanism to pinch the outer conductor at the gap.

A nineteenth embodiment includes the connector assembly of the eighteenth embodiment, the base having a recess configured to grip the outer conductor upon closing on the outer conductor. A twentieth embodiment includes the connector assembly of the eighteenth or nineteenth embodiments, the outer body being a back nut. A twenty-first embodiment includes the connector assembly of any of the eighteenth through twentieth embodiments, the outer body having an outer body threaded portion, and the assembly further having a main body with a main body threaded portion and a rear surface facing the base of the ferrule, the main body pushing the base of the ferrule as the outer body threaded portion is threadably engaged with the main body threaded portion. A twenty-second embodiment includes the connector assembly of any of the eighteenth through twenty-first embodiments, the main body having a support member projecting outward from the rear facing surface and forming a space between the base and the support member, the space configured to receive the outer conductor and said base compressing the outer conductor to the support member during compression of the base.

A twenty-third embodiment includes the connector assembly of any of the eighteenth through twenty-second embodiments, the discrete ferrule having one or more elongated arms extending outward from the base, each of the one or more elongated arms having an inward facing side with a ridge configured to selectively engage the valley to lock the coaxial cable to the outer body. A twenty-fourth embodiment includes the connector assembly of any of the eighteenth through twenty-third embodiments, the outer body having an inner surface with a recess, each of the one or more elongated arms having a foot portion with a lip projecting outward from an outer surface of each of the one or more elongated arms, the lip configured to be received at the recess. A twenty-fifth embodiment includes the connector assembly of any of the eighteenth through twenty-fourth embodiments, the outer body having an inwardly-sloped inner surface, whereby the foot engages the inner surface of the outer body to bend each of the one or more elongated arms inwardly so that the ridge engages the cable valley and locks the ferrule to the cable. A twenty-sixth embodiment includes the connector assembly of any of the eighteenth through twenty-fourth embodiments, the outer body having a step with a reduced diameter, whereby the foot engages the step to bend each of the one or more elongated arms inwardly so that the ridge engages the cable valley and locks the ferrule to the cable.

A twenty-seventh embodiment includes the connector assembly of any of the eighteenth through twenty-sixth embodiments, the outer body having a ramp configured to engage the base to reduce a diameter of the base to pinch the outer conductor. A twenty-eighth embodiment includes the connector assembly of any of the eighteenth through twenty-seventh embodiments, the base having a front base surface, and further having a post body configured to engage the outer body, the post body having a rearward surface configured to mate with the front base surface of the ferrule to push the ferrule into the outer body as the outer body is further engaged with the post body. A twenty-ninth embodiment includes the connector assembly of the twenty-eighth embodiment, wherein the post body has external threads and the outer body has internal threads that threadably engages the post body external threads.

### BRIEF DESCRIPTION OF THE DRAWINGS

FIG. 1 is a plan view of a coaxial connector assembly in accordance with embodiments disclosed herein;

FIG. 2 is a longitudinal cross-sectional view of the coaxial connector assembly shown in FIG. 1;

FIGS. 3A, 3B, 3C are enlarged longitudinal cross-sectional views showing operation of the ferrule as the cable is received in the rearward outer body;

FIG. 4 an example embodiment of a cable with a partial cross-section to illustrate the dielectric layer and the jacket;

FIG. 5A is top view of the back end of the ferrule;

FIG. 5B is a perspective view of the ferrule;

FIG. 6 is a transverse cross-sectional view of the cable; and

FIGS. 7A, 7B show another example embodiment of the coaxial cable assembly.

The figures show illustrative embodiments of the present disclosure. Other embodiments can have components of different scale. Like numbers used in the figures may be used to refer to like components. However, the use of a number to refer to a component or step in a given figure has a same structure or function when used in another figure labeled with the same number, except as otherwise noted.

### DETAILED DESCRIPTION

Various exemplary embodiments of the disclosure will now be described with particular reference to the drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the features and limitations set forth in the claims and any equivalents thereof.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

For purposes of description herein, the terms “upper,” “lower,” “right,” “left,” “rear,” “front,” “vertical,” “horizontal,” “top,” “bottom,” “side,” and derivatives thereof, shall relate to the disclosure as oriented with respect to the Cartesian coordinates in the corresponding Figure, unless stated otherwise. However, it is to be understood that the disclosure may assume various alternative orientations, except where expressly specified to the contrary.

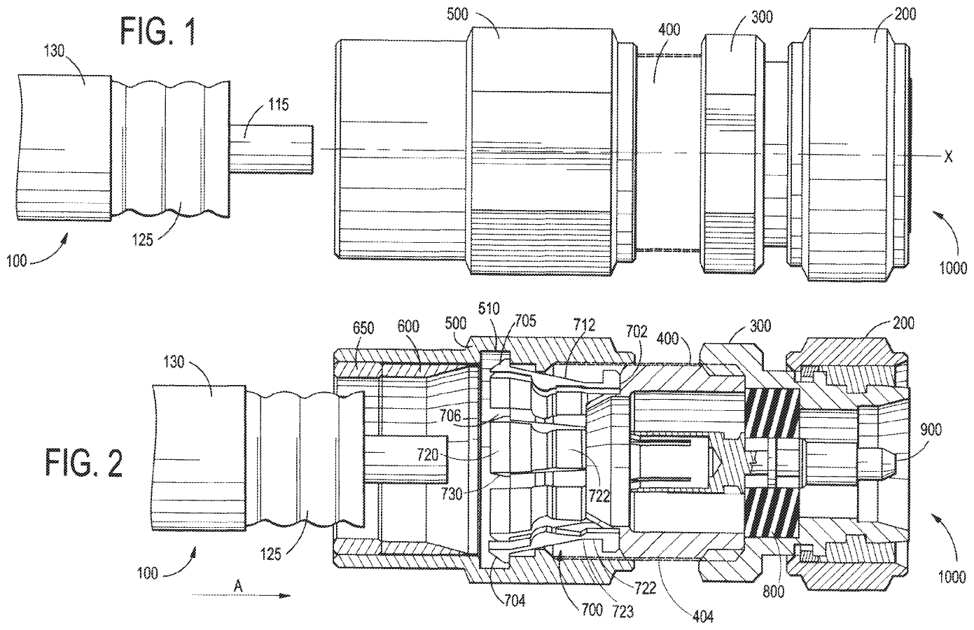

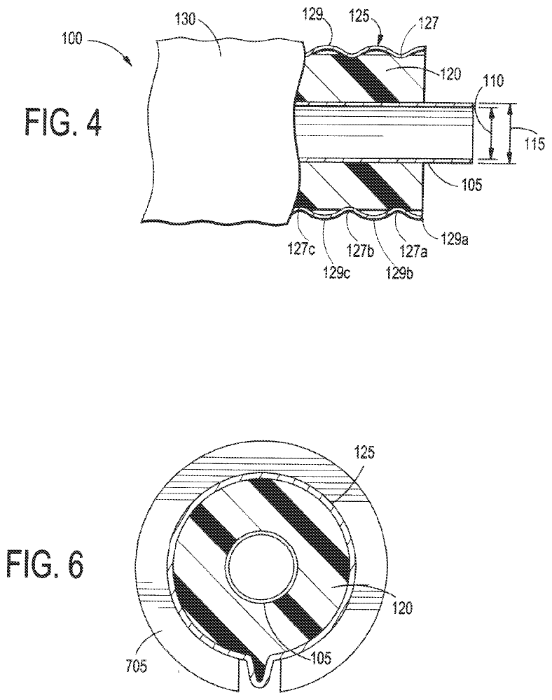

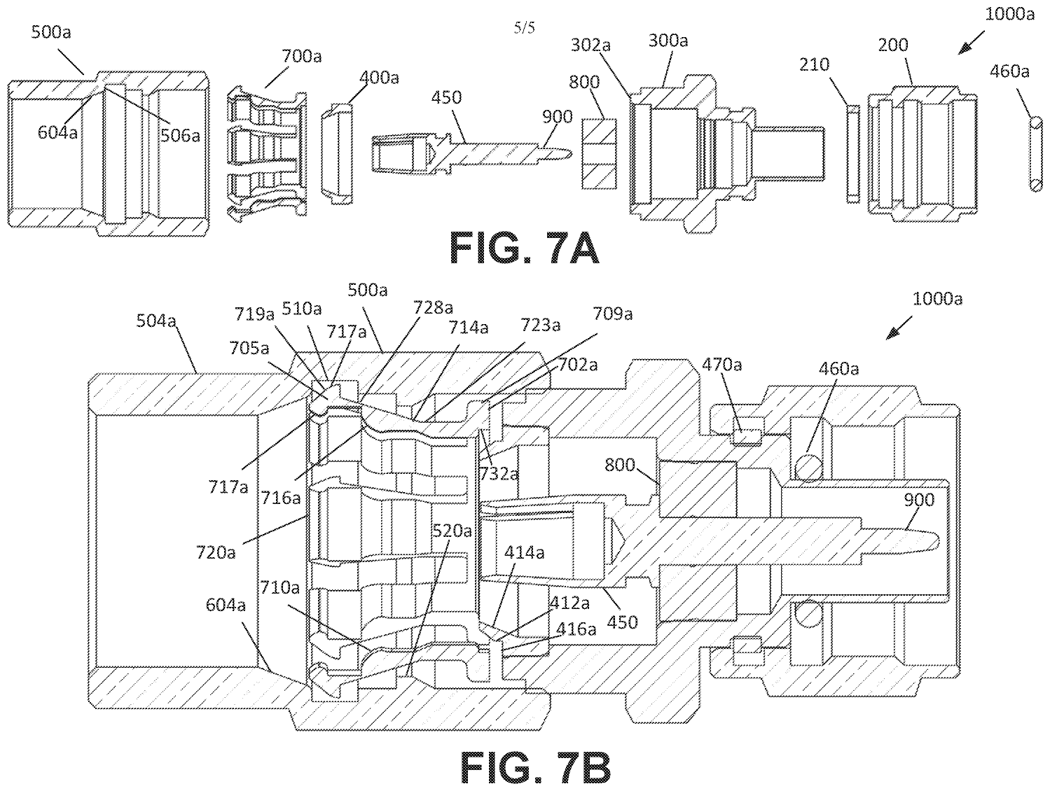

Turning to the drawings, FIGS. 1, 2 show an embodiment of a coaxial connector assembly 1000. The coaxial connector assembly 1000 has a discrete locking ferrule 700 configured for positioning onto a prepared end of a cable 100 having a corrugated outer conductor 125 (also see FIGS. 4, 6). This embodiment of the coaxial cable assembly 1000 includes a forward outer body 200 (e.g., such as an interface nut), a main or intermediate body 300, a post body 400, a center conductor 450 (also see FIG. 7) having a contact element 900, a rearward outer body 500 (e.g., such as a back nut), a first rear inner body 600, a second rear inner body 650, a cable engagement member such as for example a ferrule 700, and an insulator 800. The coaxial connector assembly 1000 is configured for assembly with the cable 100. At least the forward outer body 200, intermediate body 300, post body 400, rearward outer body 500, first and second inner bodies 600, 650, isolator 800, and ferrule 700 share a common central longitudinal axis X.

The isolator 800 holds the inner conductor 450 in place and centered. The inner conductor 450 is an elongated rod-shaped member, as best shown in FIG. 7A The isolator 800 is received in the intermediate body 300. The isolator 800 has a central opening that receives the inner conductor 450.

The forward outer body 200 can be coupled to an electronic component, such as the cable of an antenna (not shown) that mates with the cable 100. The intermediate body 300 mates with the forward outer body 200 and has an internal threaded portion at the rear end of the intermediate body 300. The post body 400 has an external threaded portion at the forward end of the post body 400 that threadably engages the internal threaded portion of the intermediate body 300. The post body 400 also has a back end with a rear surface 402. The rear surface 402 extends substantially transversely, and orthogonal to the longitudinal axis X of the assembly 1000. The post body 400 is fixed to the intermediate body and the forward outer body 200 by virtue of the threaded engagements.

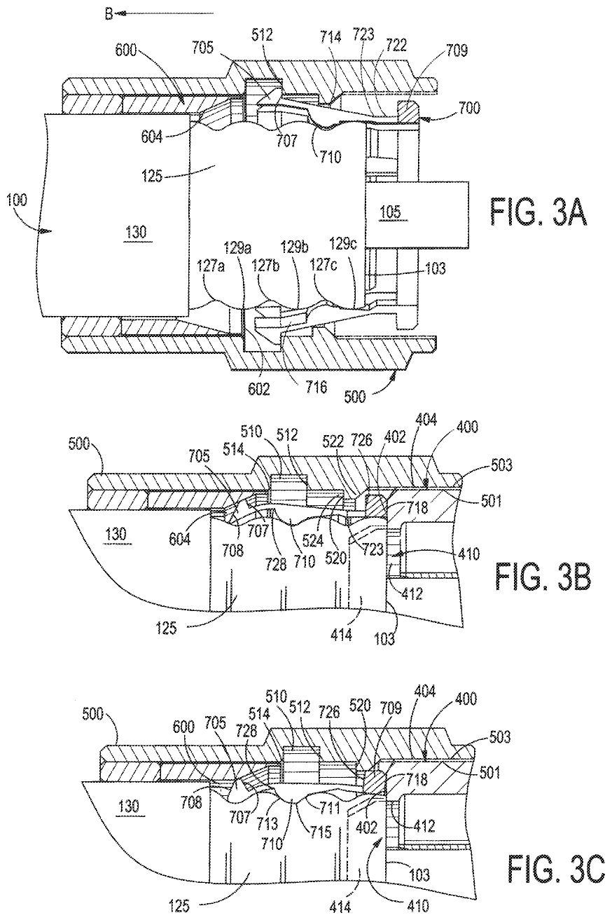

Referring to FIGS. 2, 3, the rearward outer body 500 has an inner surface 501, a front engaging section 502 and a back receiving section 504. The back receiving section 504 receives the cable 100 through the back end of the back receiving section 504. In some embodiments, the front engaging section 502 has a threaded section 503 that threadably engages with the body 400, though in other embodiments the front engaging section 502 can be smooth and unthreaded.

A compression mechanism, here shown as an annular ramp 520, is positioned to extend annularly about the inner surface 501, behind the threaded section 502. The ramp 520 can be located at either the front engaging section 502 or the back receiving section 504, or even in the rear inner body 600. The ramp 520 projects outward from the inner surface 501 of the outer body 500, and inwardly toward the center of the connector assembly 1000. The ramp 520 has a sloped leading surface 522 and a rear side lip 524. The sloped leading surface 522 can be a straight surface, as shown, or can be curved. The rear side lip 524 extends substantially orthogonal to the inner surface 501.

An annular recess 510 is positioned to extend annularly about the inner surface 501, behind the annular ramp 520. As shown, the annular recess 510 can be at the end of the front engaging section 502 and directly adjacent to the back receiving section 504. In particular, the recess 510 is directly adjacent to a sloped surface 604 (here shown in the back receiving section 504) so that the foot 705 of the ferrule 700 can travel directly from the recess 510 to the sloped surface 604, though in some embodiments the recess 510 can be at a distance from the sloped surface 604. The recess 510 can be separated from the annular ramp 520 by a distance, as shown, or can be directly adjacent one another. The recess 510 extends into the inner surface 501 to define a recessed space within the recess 510. The recess 510 can be positioned in the front engaging section 502 of the outer body 500, as shown, though in other embodiments the recess 510 can be positioned in the back receiving section 504 or in the rear inner body 600.

As further illustrated in FIG. 2, an inner body is positioned inside the back receiving section 504 of the rearward outer body 500. In the example embodiment shown, the inner body is shown as the first (or forward) inner body 600 and the second (or rear) inner body 650, though in other embodiments, the first and second inner bodies 600, 650 can be a single-piece integrated body. The inside surface of the leading end 602 of the first rear inner body 600 has an inwardly sloped surface 604 to be tapered so that the opening at the leading end is wide and then narrows. In yet other embodiments, the inner body need not be separate from the rearward outer body 500. Instead, as illustrated in FIGS. 7A, 7B, the back receiving section 504a of the rearward outer body 500 is a single integral piece having a leading end 506a and a sloped surface 604a. The sloped surface 604a can be directly at the leading end 506a, or can be separated from the leading end 506a by a distance. And the recess 510a can be directly adjacent to the sloped surface 604a and/or the leading end 506a, or separated from the sloped surface 604a and/or leading end 506a by a distance.

Referring to FIGS. 1, 4, 6, the cable 100 generally includes at least a center conductor 105, a dielectric 120, a corrugated outer conductor 125, and a jacket 130. The center conductor 105 is annular and thus includes an inside diameter 110 and an outside diameter 115. The dielectric 120 surrounds the outside diameter 115 of the center conductor 105, while the corrugated outer conductor 125 surrounds the dielectric 120, and the jacket 130 surrounds the corrugated outer conductor 125. The corrugated outer conductor 125 has one or more ridges or peaks 129 and valleys 127. In the embodiment of FIG. 4, there is a series of a first peak 129a, a first valley 127a, a second peak 129b, a second valley 127b, a third peak 129c, and a third valley 127c. It is noted that the outer conductor 125 need not start with a first peak 129a, but instead can start with a first valley 127a, or a position between a valley and a ridge. A forward end of the corrugated coaxial cable 100 is shown in a prepared state, meaning that at an end of the corrugated coaxial cable 100, a portion of the jacket 130 has been removed such that the corrugated outer conductor 125 is fully exposed and ready for positioning in the connector assembly 200.

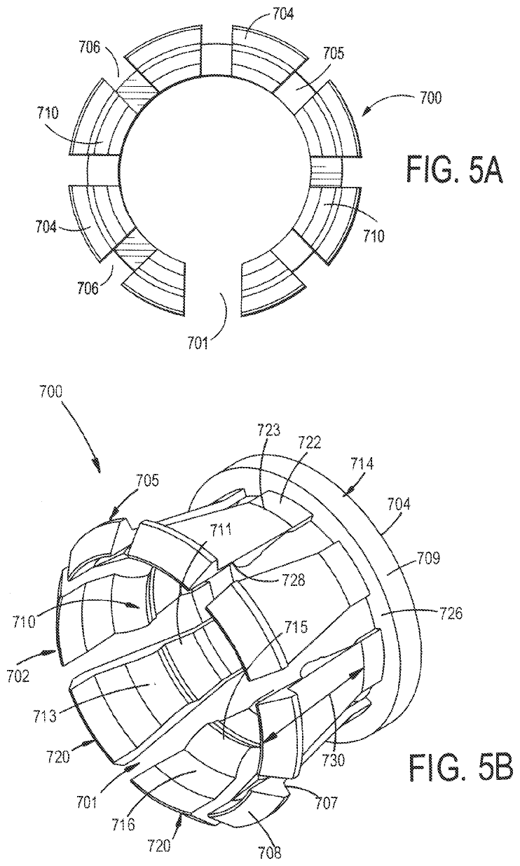

The ferrule 700 is best shown in FIGS. 2, 3, 5. The ferrule 700 is a discrete member that is configured to substantially engage with the corrugated outer conductor 125 of the corrugated coaxial cable 100 after the jacket 130 has been stripped back to expose a portion of the corrugated outer conductor 125. The ferrule 700 also selectively engages the rearward outer body 500.

Referring to FIGS. 2, 3, 5, the ferrule 700 includes a front ferrule end 702, a back ferrule end 704, and an intermediate portion 712 between the front and back ferrule ends 702, 704. The front ferrule end 702 has a base 709, the back ferrule end 704 has a widened foot portion 705, and the intermediate portion 712 has a ridge 710.

The base 709 forms an open ring with a single gap 701 to have a C-shape. The ferrule 700 has an outer surface 714 that faces outward with respect to a center of the ring, and an inner surface 716 that faces inward toward the center of the ring. The base 709 has a front base surface 718 that forms the leading front ferrule end 702. The front base surface 718 is substantially orthogonal to the outer surface 714 of the base 709, and the corner can be angled where the front base surface 718 meets the outer surface 714 of the base 709. Thus, the front base surface 718 extends substantially orthogonal to the inner surface 501 of the rearward outer body 500, and substantially parallel to the rear surface 402 of the post body 400.

The intermediate portion 712 has a plurality of thin elongated arms 720 that extend outward from the base 709 and are separated by a plurality of elongated slots 706. The gap 701 at the base 709 can be substantially the same distance as the width of the slots 706 between the arms 720, so that the arms 720 are spaced equidistant about the base 709 and the C-shaped ring formed by the base 709 is nearly a full circle. A proximal end of each arm 720 extends substantially orthogonally outward from the base 709. The proximal end of the arm 720 is substantially thinner than the base 709 and extends from the inner side of the base 709. Accordingly, where the arm 720 meets the base 709, a lip 726 is formed at the outer surface 714, but the inner surface 716 is substantially even and continuous. The entire ferrule 700, including the base 709 and arms 720, form a single-piece integral unitary member.

As further shown in FIGS. 2, 3, the proximal end of the arm 720 has a flat section 722 and a tapered section 730. The flat section 722 thins to form a first fold or bend line 723. For example, the entire flat section 722 can have straight inner and outer surfaces 716, 714, but gradually thin to the bend line 723. Or, as shown, the flat section 722 can have an angled section at the inner surface 716 that tapers outward with respect to the center of the C-ring. In addition, the tapered section 730 can get thicker from the bend line 723 toward the ridge 710. In addition, the ferrule arm 720 is also narrowed just behind the ridge 710 in the ferrule travel direction shown by arrow B, to define a second bend line 728. That is, the arm 720 has a reduced thickness at the trailing side of the ridge 710, then gets gradually thicker to the foot 705 and the back ferrule end 704. Thus, the arm 720 has a thickness that varies along its length, with the first and second bend lines 723, 728 being the thinnest parts of the arm 720. Accordingly, the arm 720 can flex inwardly along the first and second bend lines 723, 728 during insertion of the cable assembly 100. Accordingly, the ferrule 700 bends along the bend lines 723, 728 to conform to the shape of the cable outer conductor 125 to provide a large surface area where the ferrule 700 couples with and locks to the outer conductor 125. This provides a reliable mechanical and electrical connection (here, a ground connection) between the cable 100 (via the outer conductor 125) and the back nut rearward outer body 500 (via the ferrule 700).

The foot portion 705 is located at the back ferrule end 704. The foot portion 705 has a cross-section with a substantially triangular shape defined by a leading lip 707 and a rear sloped surface 708. The leading lip 707 extends outward from the outer surface 714 of the ferrule 700. The rear sloped surface 708 can be straight or curved. The leading lip 707 is configured to engage the rearward outer body 500 by contacting the leading lip 512 of the recess 510 when the foot portion 705 is aligned with and received in the recess 510. Accordingly, as shown in FIG. 3A, the leading lip 707 is straight and configured to be substantially parallel to the leading lip 512 of the recess 510 when the ferrule 700 is in a first position and the foot portion 705 is aligned with and received in the recess 510. In that first position, the leading lip 707 can be at an obtuse angle to the outer surface 714, though in a stressed second position (FIGS. 3B, 3C) the leading lip 707 can be at an acute, obtuse or orthogonal angle to the outer surface 714 of the ferrule 700. As further illustrated in FIG. 3B, the trailing lip of the recess 510 can have an angled corner 514, which cooperates with the rear sloped surface 708 of the ferrule 500 to facilitate the ferrule 500 moving to the rear inner body 600.

Referring to FIGS. 3A-3C, the ridge 710 has a leading surface 711, trailing surface 713, and apex or tip 715 between the leading surface 711 and the trailing surface 713. The leading surface 711 can be curved or rounded, as shown, or a gradual slope extending to the bend line 723. The trailing surface 713 can also be curved or rounded, as shown, or an angled straight surface.

As best shown in FIGS. 2, SB, the ferrule arm 720 also has a varying width (i.e., transverse distance of the outer and inner surfaces 714, 716 of the ferrule arms 720). More particularly, in the example embodiment shown, the tapered section 730 tapers outwardly from the first bend line 723 to the leading lip 707, then narrows again slightly to the back ferrule end 704. The tapered section 730 is widest at the leading lip 707 of the foot portion 705 than at the first bend line 723. Thus, the flat section 722 has a constant width up to the first bend line 723, then gradually widens to the leading lip 707 of the foot portion 705 and then slightly tapers inward at the rear sloped surface 708 to narrow the width to the back ferrule end 704.

FIG. 2 shows the ferrule 700 in a ready position, prior to insertion of the cable assembly/cable 100. In the ready position, the tapered section 730 is slightly bent at the bend line 723 with respect to the flat section 722. Thus, the side (i.e., cross-sectional) view of the ferrule 700 shows that the tapered section 730 forms an obtuse angle with respect to the flat section 722. In this figure, the cable 100 is shown disconnected from the assembly 1000 at the rear inner bodies 600, 650 at the rear receiving section 504 of the rearward outer body 500. The ferrule 700 is in a first or relaxed position, in which the arms 720 are not biased inward or outward.

Accordingly, the arms 720 can move inward and outward with respect to the recess 510.

The front ferrule end 702 is configured to contact the post body 400. In addition, the plurality of ferrule ridges 710 are configured to contact and engage with the valleys 127 and peaks 129 in the outer conductor 125 of the corrugated coaxial cable 100, as shown particularly in FIG. 3. And the back ferrule end 704 is configured for engagement with a recessed area 510 in the rearward outer body 500 in a first position, shown in FIGS. 2, 3A, and the first rear inner body 600 in a second position, shown in FIGS. 3B, 3C.

The assembly 1000 includes an active unit and a passive unit. In one embodiment, each of the active unit and the passive unit are preassembled to be coupled together, such as during manufacturing or prior to delivery to the end user. The passive unit includes the intermediate body 300, the interface nut or forward outer body 200, isolator 800, center conductor 450 and post 400. The intermediate body 300 is preassembled with the O-ring 460a (FIG. 7, if used), forward outer body 200, isolator 800, center conductor 450, post 400, and lock ring 210 (FIG. 7, if used). For example, the forward outer body 200 is threadably engaged with the intermediate body 300, which in turn is threadably engaged with the post body 400.

The active unit includes the ferrule 700 and the back nut or rearward outer body 500. During preassembly, as shown in FIG. 2, the ferrule 700 is inserted into the front engaging section 502 of the rearward outer body 500 in a ferrule travel direction shown by arrow B. When the ferrule 700 is fully inserted into the back nut rearward outer body 500, the ferrule arms 720 are wider than the inner diameter of the rearward outer body 500 so that the foot 705 is received in the recessed space of the recess 510. The ferrule leading lip 707 and the recess lip 512 prevent the ferrule 707 from inadvertently uncoupling from the rearward outer body 500.

A tool can be utilized to compress the ferrule arms 720 inwardly during insertion and allow the arms 720 to expand back outward into the recess 510, so that the ferrule 700 does not contact the inner surface 501 of the rearward outer body 500. In other embodiments, the ferrule foot 705 can slide along the inner surface 501 during insertion, past the ramp 520 and into the recess 510. At this point, the ferrule 700 cannot be removed from the rearward outer body 500 (i.e., in the insertion direction A) because the leading lip 707 would engage the rear side lip 524 of the ramp 520.

Operation of the assembly 1000 will now be discussed with respect to FIGS. 2, 3, whereby the cable 100 is inserted into the connector assembly 1000 in an insertion direction shown by arrow A (to the right in the embodiments of FIGS. 2, 3), which is opposite the ferrule insertion direction B. As illustrated in FIG. 3A, the active unit has been preassembled, with the foot portions 705 of the ferrule 700 received in the recess 510. The ferrule 700 is prevented from moving in the insertion direction A The outward spring force of the ferrule arms 720 keeps the foot 705 in the recess where the leading lip 707 of the foot 705 engages the leading lip 512 of the recess to prevent the ferrule 700 from moving in the insertion direction A The ferrule foot 705 can move forward and backward within the recess 510, but the outward spring bias of the ferrule arms 720 prevents the ferrule 700 from escaping the recess 510 in the ferrule travel direction B. However, in other embodiments, the ferrule foot 705 need not be received in the recess 510, but can instead be aligned with the recess 510.

The ferrule 700 is now in a ready position, and able to accept the cable 100. Referring to FIGS. 3A, 4, the cable 100 is being inserted into the back nut or rearward outer body 500. This operation can be performed by the user in the field, or during preassembly. The cable 100 is pushed through the back receiving section 504 of the back nut or rearward outer body 500. As shown, the center conductor 105 comes into contact with, and is received in, a mating receptacle of the connector center conductor 450. And, the corrugated outer conductor 125 comes into contact with the ridge 710 of the ferrule 700. As the cable 100 is inserted, the peaks 129 of the corrugated outer conductor 125 press the ferrule 700 outwardly.

In FIG. 3A, the ridge 710 is aligned with a valley 127 (here shown as the first valley 127a) of the outer conductor 125, and the ferrule foot 705 is partly received in the recess 510. As the cable 100 is further inserted, the peak 129 (here shown as the second peak 129b) of the outer conductor 125 pushes the ferrule foot 705 further into the recess 510. When the cable 100 is fully inserted into the rearward outer body 500 (as shown in FIGS. 3B, 3C), the ferrule ridge 710 will be aligned in a valley 127 (here shown as the second valley 127b) and the foot 705 is aligned in a valley 127 (here shown as the third valley 127c) of the outer conductor 125, and the foot 705 moves inward again, out of the recess 510 to the same position in the recess 510 as shown in FIG. 3A. Accordingly, the recess 510 allows the foot 705 to move inward and outward as the cable 100 is inserted and the ferrule ridge 710 contacts the valleys 127 and peaks 129 of the outer conductor 125. In addition, the leading surface 711 of the ridge 710 cooperates with the trailing surface of the peak 129 to apply a forward insertion force to the cable 100 in the cable insertion direction A, and prevent the cable 100 from being inadvertently removed from the rearward outer body 500. Notably, the ramp 520 does not obstruct that motion of the ferrule 700.

Once the cable 100 is fully inserted into the rearward outer body 500, the distal end 103 of the forward end of the cable 100 is aligned with the front base surface 718 of the ferrule base 709, as shown in FIG. 3B. The prepping of the cable 100 only exposes 2-5 peaks 129. The jacket 130 prevents the cable 100 from being pushed any further.

Once the cable 100 is fully inserted into the rearward outer body 500 in the cable insertion direction A, the passive unit can then be engaged to the active unit. Thus, the rearward outer body 500 can now be threadably engaged to the post body 400. The rearward outer body 500 with the cable 100, is then installed on the passive unit, i.e. at the body 300. The outer threaded portion of the post body 400 threadably engages the inner threaded portion 503 of the rearward outer body 500. When the rearward outer body 500 is rotated with respect to the cable 100 and the post body 400, the threads 503 of the rearward outer body 500 engage the threads of the post body 400, so that the ferrule 700 and the rearward outer body 500 start moving forward with respect to the post body 400 (i.e., the rearward outer body 500 is pulled toward the post body 400.

As further illustrated in FIGS. 3A-3C, the post body 400 has support member projecting outward from the rear surface 402 of the post body 400. In the example embodiment shown, the support member is a neck 410 with a straight section 412 and an inwardly-turned angled section 414. The neck 410 extends outward with respect to the rear surface 402 of the post body 400. The diameter of the ferrule base 709 is larger than the diameter of the neck 410 and the diameter of the outer conductor 125. In addition, the inner diameter of the outer conductor 125 is larger than the outer diameter of the neck 410 and the outer diameter of the outer conductor 125 is smaller than the diameter of the ferrule base 709.

Thus, as the rearward outer body 500 and post body 400 come together, at some point, as illustrated in FIG. 3B, the outer conductor 125 slides into the space formed between the ferrule inner surface 716 at the base 709, and the outer surface of the inner post body neck 410. Accordingly, the ferrule base 709 sits around the straight and angled sections 412, 414 of the neck 410, and the outer conductor 125 is sandwiched between the ferrule base 709 and the straight and/or angled sections 412, 414 of the neck 410. In addition, the rear surface 402 of the post body 400 comes into contact with the front base surface 718 of the front end 702 of the ferrule 700. And, in the event the user over-inserts the cable 100 into the rearward outer body 500, the front base surface 718 will push the distal forward end 103 of the outer conductor 125 into position to align with the front base surface 718 of the base 709.

As the rearward outer body 500 continues to be threaded onto the post body 400, the post body 400 is drawn further into the front engaging section 502 of the rearward outer body 500. As the post body 400 moves inwardly forward, the rear surface 402 of the post body 400 presses the ferrule 700 in the ferrule travel direction B with respect to the rearward outer body 500. However, the post body 400 pushes the front base surface 718 base 709 and the distal forward end 103 of the outer conductor 125. Accordingly, the ferrule 700 only moves with respect to the rearward outer body 500, but remains fixed with respect to the outer conductor 125 and the cable 100.

At the same time that the rear surface 402 of the post body 400 contacts the front base surface 718 of the ferrule 700 and the distal forward end 103 of the cable outer conductor 125, the ferrule ridge 710 substantially aligns with or about a valley 127 (here, the second valley 127b) of the outer conductor 125 and the foot 705 substantially aligns with a valley 127 (here, the third valley 127c), as shown in FIG. 3B.

Accordingly, turning to FIG. 3B, the cable 100 has been inserted into the rearward outer body 500 in the cable insertion direction A, and the post body 400 has come into contact with the cable end 103 and the ferrule front base surface 718. The rearward outer body 500 has been further threaded to the post body 400, which has moved the ferrule 500 inwardly into the rearward outer body 500. The post body 400 forces the ferrule 700 forward in the ferrule travel direction B. However, the ferrule 500 remains at a fixed position with respect to the cable 100, whereby the ferrule ridge 710 remains aligned with a cable valley 127 (here, the second valley 127b), and the ferrule foot 705 remains aligned with a cable valley 127 (here, the third valley 127c). Accordingly, the ferrule 700 has moved out of the recess 510 and onto the sloped surface 604. The ferrule angled rear sloped surface 708 and the angled recess corner 514 push the ferrule arms 720 inward and enable the foot 705 to slide up the rear lip of the recess 510 to the sloped surface 604. The rear sloped surface 708, forces the arms 720 inward and the foot 705 travels out of the recess 510 into the first rear inner body 600.

The rear sloped surface 708 of the ferrule foot 705 then travels along the sloped inner surface 604 of the first rear inner body 600. As the diameter of the sloped inner surface 604 gets smaller, the ferrule arms 720 are pressed inward. As a result, the tapered section 730 flexes inward at the first bend line 723, and the inner surface 716 becomes substantially linear from the flat section 722 to the tapered section 730, as shown in FIG. 3B. That further seats the ridge 710 in the valley 127 of the outer conductor 125. The ferrule trailing surface 713 cooperates with the leading surface of the cable peak 129 (here, the third peak 129c), and the ferrule leading surface 711 cooperates with the trailing surface of the cable peak 129 (here, the second peak 129b), to further lock the ferrule 700 to the cable 100 to prevent the cable 100 from moving forward in the cable insertion direction A, or rearward (opposite the cable insertion direction A), respectively.

Moving from FIG. 3B to FIG. 3C, the user continues to thread the rearward outer body 500 to the plug body 400, and the leading surface 711 of the ridge 710 pushes on the trailing side of the peak 129. The ferrule ridge 710 remains aligned and engaged with a valley 127 (here, the second valley 127b) of the outer cable conductor 125 and the ferrule foot 705 remains aligned with a valley 127 (here, the third valley 127c). And the sloped inner surface 604 continues to push inward on the foot 705, which bends the foot 705 inward along the second bend line 728. The ridge 710 has a rounded shape and (optionally) size that conforms to the shape (e.g., curvature) of the valley 127 (here, the second valley 127b). The foot 705 is received in the third valley 127c, and substantially conforms under pressure to the shape (e.g., curvature) and (optionally) size of the third valley 127c. Since the ridge 710 is seated in the valley 127, the ferrule bends at the second bend line 728. The ridge 710 and foot 705 each separately engage and lock the ferrule to the cable 100 via the outer conductor 125 at the second and third valleys 127b, 127c, respectively.

At the same time, the base 709 of the ferrule 700 travels up the sloped leading surface 522 of the ramp 520. In the embodiment shown, the base 709 travels to the inner-most portion of the ramp 520, so that the outer surface 714 of the base 709 contacts the inner surface 501 of the rearward outer body 500. That forces the base 709 inward, reducing the diameter of the ferrule base 709. As a result, as best shown in FIG. 6, the C-ring closes at the gap 701, and the base 709 pinches the corrugated outer conductor 125 together at the gap 701. That is, the compression mechanism, ramp 520, asserts a compression force on the base 709 which in turn exerts a compression force on the outer conductor 125 to pinch the outer conductor 125 and compress the outer conductor 125 to the support member, the straight section 412 and/or the angled section 414.

Thus, in the final movement (e.g., 3-4 mm) towards the full mechanical stop (when the front lip of the back nut 500 meets the intermediate body 300), the C-ring ramp 520 compresses the cable front end. At this point, the cable has reached the stop at the forward outer conductor flange. As the cable 100 and ferrule 700 cannot move forward, the C-ring base 709 is compressed, closing the diameter of the outer conductor to meet the diameter of the post 400. As the ferrule base 709 pinches together, it locks the cable 100 at the outer conductor 125 to the post body 400 at the neck 410 between the post 400 and the ferrule 500. The small lump of outer conductor material is locked in the C-ring, preventing the cable from rotating and the ferrule has been locked by the high amount of friction force applied to the unit. The inwards movement of the tapered part of the ferrule helps to push the cable forward for full seating as the ridges 710 of the ferrule move inwards pressing the cable corrugation forward. In some embodiments, the neck 410 need not have both a straight section and an angled section, but can have either a straight section or an angled section. The base 705 can further angle inward, as shown, or the ferrule can be straight.

Accordingly, the outer conductor 125 is pinched together within the gap 701 of the base 709, which prevents rotation of the ferrule 700 with respect to the cable 100. The compression is uniform about the outer conductor, so the change in the outer conductor is done evenly and the center conductor 105 remains centered in the cable 100. The base 709 also grips the outer conductor 125, which prevents the cable 100 from moving forward and rearward with respect to the ferrule 700. And, the ferrule 700 is locked to the outer conductor 125. This provides a reliable mechanical and electrical (ground) connection between the ferrule and the base 709.

As further illustrated in FIG. 3C, the ferrule ridge 710 has substantially the same shape (e.g., curvature) and (optionally) size as the outer conductor (e.g., the valley 127), which maximizes the surface area at which the ferrule 700 mechanically contacts with the outer conductor 125 to aid in locking the ferrule to the cable. The enhanced surface contact also provides a more reliable electrical connection between the ferrule 700 and the outer conductor 125, providing for a more reliable ground in the example embodiment shown.

The plurality of slots 706 in the ferrule 700 provide the arms 720 of the ferrule 700 with spring-like characteristics to be able to move inwardly and outwardly. Accordingly, the plurality of slots 706 facilitate spring-like engagement of the ferrule 700 upon coupling with the corrugated outer conductor 125, the rearward outer body 500 and the first rear inner body 600. The annular ridges 710 also facilitate engagement with the corrugated outer conductor 125 by nature of the ridges themselves cooperating with the peaks 129 and valleys 127 of the outer conductor 125, resulting in a locking effect. This locking effect is used to effectively hold the cable in position during installation, assist in seating the cable properly during tightening of the assembly, and lock the cable in position upon completion of the installation process (the cable is held into place by the ridge of the ferrule closing in in the recess area of the cable outer conductor corrugation). The ferrule has several functions. It holds the cable in position during installation, assists in seating the cable properly during tightening, and locks the cable (both due to geometry and to a compression ring in front). The connector can be used both as a single piece (with all parts assembled) or as a two-piece (back nut with ferrule as one piece, and the body as a second piece).

FIGS. 7(a), 7(b) show another example embodiment of the coaxial connector assembly 1000a. As shown, the forward outer body 200 with an optional interface nut locking C-ring 210, center conductor 450, and isolator 800 and ferrule 700, are the same as in the assembly 1000 of FIGS. 2-6. Here, however, an optional O-ring 460 (e.g., to render the assembly 1000 watertight) is also illustrated. And, additional example embodiments of the intermediate body 300a, post body 400a, ferrule 700a and rearward outer body 500a are shown. It is further noted that the forward outer body 200 (e.g., for a male connector) and intermediate body 300 (e.g., the interface) can vary in design. The center conductor 450 can also vary in design, and an N male interface is shown in FIG. 7.

Another example embodiment of the ferrule 700a is illustrated in FIG. 7. As best shown in FIG. 7B, a small annular notch or recess 732 is made in the base 709 at the inner corner of the front base surface 718 and the ferrule inner surface 716. The annular recess 732 assists the ferrule 700 in holding the cable 100 during the forward movement of the back nut rearward outer body 500 during torque. The sharp corners of the recess 732 dig into the outer conductor 125 to further facilitate the ferrule 700 gripping the cable conductor 125. It also assists in holding the cable in position when the C-ring is locked, by preventing the cable 100 from otherwise backing out of the ferrule 700 (i.e., in the ferrule travel direction B) when the diameter of the base 709 closes around the cable 100.

As further shown in FIG. 7, the intermediate body 300a can have a rear portion with a trailing surface 302a. And the post body 400a can be reduced in size to a ring-type structure having base with a support member extending outward from the base. In the example embodiment shown, the support member is a neck having an angled section 414a with a straight section 412a on an outer surface. The base also has a forward section 416a. The post body 400a can be connected to the rear portion of the intermediate body 300a, such as by external threads of the post base engaging internal threads at the rear portion of the intermediate portion 300a. The outer conductor 125 is received between the ferrule recess and the straight and angled sections 412a, 414a. The distal end 103 of the conductor 125 can be pushed by the forward section 416a of the post body 400a, and the front end 702a of ferrule base 709 can be pushed by the trailing surface 302a of the intermediate body 300a and/or the forward section 416a of the post body 400a.

FIG. 7 further shows the ferrule foot 705a having a different configuration than the ferrule foot 705 of FIGS. 1-6. In particular, the foot 705a is more closely shaped and (optionally) sized to match the shape and size of the valley 127. The foot 705a has a rounded inner contact surface 717a formed at the inner surface 716a of the ferrule arm 720a. The rounded inner contact surface 717a substantially conforms to the shape (e.g., curvature) and (optionally) size of the valleys 127 of the outer conductor 125, to further enlarge the surface area contact between the ferrule 700 and the outer conductor 125. That, in turn, improves the mechanical connection between the ferrule 700 and the cable conductor 125 to better lock the ferrule 700 to the cable conductor 125. And, it enhances the electronic connection to provide a better ground between the ferrule 700 (and the intermediate body 300a) and the cable conductor 125.

In addition, the inner surface 716a and the outer surface 714a are more rounded at the foot 705a, to facilitate the foot 705a moving out of the recess 510a to the sloped surface 604a. The rounded shape of the foot 705a also ensures that the arm 720a bends along the second bend line 728a and into the cable conductor valley 127 and does not bend away from the valley 127 to conform to the shape of the sloped surface 604a. In particular, the outer surface 714a at the foot 705a has a leading outer contact surface 717a and a trailing outer surface 719a. The leading outer contact surface 717a is angled inward with respect to the trailing outer surface 719a. The leading outer contact surface 717a is relatively flat and configured to be substantially parallel to the sloped surface 604a so that the leading outer contact surface 717a pushes the head 705a into the valley 127 along the second bend line 728a. In addition, the second bend line 728a is much thinner than the first bend line 723a.

In one embodiment, the ferrule 700, 700a is made of conductive metal material, and each component is preferably made of at least one metallic material, such as tin-bronze, brass or another comparable material, and can also be plated with at least one conductive material, such as nickel-tin. The outer conductor 125 can be, for example, copper or aluminum. In one embodiment, the assembly is fire-resistant and can withstand high temperatures, for example 1800 F degrees for two hours. To accommodate high thermal expansion, a very large mechanical contact surface and high contact ratio between the outer conductor and the connector body is provided, which has a reliable grip of the cable. In particular, the ferrule 700, 700a provides a large contact surface with the outer conductor. The present assembly does not lose its rotational grip due to thermal expansion and degradation of internal forces. In certain embodiments, the ferrule 700, 700a is made of the same material as the rest of the connector, so that the thermal expansion and contraction of the components are the same for all components. The features shown with respect to the example embodiments of the assembly 1000, 1000a can be used on any connector where stability is needed, such as to prevent rotation of the connector with respect to the cable or where high mechanical stability is needed. In other embodiments of the disclosure, the ferrule 700, 700a can be made of plastic.

It is noted that the ferrule ridge 710, 710a cooperates with the peaks 129 and valleys 127 as discussed above. However, the ridge 710, 710a can be configured to cooperate with the peaks 129 and valleys 127 in other manners, within the spirit and scope of the present disclosure. In addition, while the apparatus 1000, 1000a has been described as fire resistant and for use in high temperature environments, which are not typically suitable for plastics (that melt at low temperatures (160-200 degrees C.)); other applications and configurations can be provided. For example, the ferrule can be made of plastic to accommodate low PIM (passive intermodulation) needs. And, the isolator can be made of any material suitable for the application, and in one embodiment the isolator is ceramic for high temperature applications. In addition, the connector can have any suitable interface, and need not have the center conductor 105 and mating receptacle as discussed above. In one embodiment, the rearward outer body 500, 500a is preinstalled on the front part of the connector, so the user only has to prepare the cable to expose the outer conductor and insert it into the connector and tighten the rearward outer body 500, 500a. Still further, the arms 720, 720a are sufficient rigid to provide a spring force, but allow for bending at the bend lines 723, 723a, 728, 728a.

It is further noted that once the ferrule 700, 700a is installed to the cable 100, the ferrule 700, 700a cannot be removed from the cable 100. However, in other embodiments, the ferrule 700, 700a can be designed so that it can be removed from the cable 100.

It is also noted that for the purpose of clarity, only those elements of FIG. 7 that differ from FIGS. 1-6 have been discussed here and not all of the common elements from FIGS. 1-6 have been described with respect to FIG. 7. However, it will be recognized that the structure and operation of the assembly is otherwise the same in FIG. 7 as in FIGS. 1-6. For example, the ferrule gap 701 is not discussed with respect to FIG. 7. But those elements (such as the slots 706, gap 701, threaded section 503, etc.) is the same in FIG. 7 as with FIGS. 1-6.

For the purposes of describing and defining the subject matter of the disclosure it is noted that the terms “substantially” and “generally” may be utilized herein to represent the inherent degree of uncertainty that may be attributed to any quantitative comparison, value, measurement, or other representation.

It is noted that the drawings may illustrate, and the description and claims may use geometric or relational terms, such as leading, trailing, front, back, foot, rear, inner, outer, left, right, elongated, rod, circular, angled, C-shape, parallel, orthogonal, inwardly, outward, sloped, and forward. These terms are not intended to limit the disclosure and, in general, are used for convenience to facilitate the description based on the examples shown in the figures. In addition, the geometric or relational terms may not be exact. For instance, walls may not be exactly perpendicular or parallel to one another because of, for example, roughness of surfaces, tolerances allowed in manufacturing, etc., but may still be considered to be perpendicular or parallel.

Thus, for example, a sloped surface 604, 604a is shown and described. However, the surface 604, 604 need not be sloped, but can be, for example, a stepped surface that is not at an angle. Thus, the stepped surface can have one or more steps, each step having a same diameter at the front and end, but each step having a smaller diameter than the former step.

It will be apparent to those skilled in the art that various modifications and variations can be made without departing from the spirit or scope of the disclosure. Since modifications, combinations, sub-combinations and variations of the disclosed embodiments incorporating the spirit and substance of the disclosure may occur to persons skilled in the art, the embodiments disclosed herein should be construed to include everything within the scope of the appended claims and their equivalents.

1. A connector assembly (1000, 1000a) for attachment to a corrugated coaxial cable (100), the corrugated coaxial cable (100) comprising a center conductor (105), a dielectric (120) surrounding the center conductor (105), and a corrugated outer conductor (125) surrounding the dielectric (120), the connector assembly (200) comprising:
a rearward outer body (500, 500a) to be received over a portion of the corrugated coaxial cable (100), the rearward outer body (500, 500a) comprising a recessed area (510, 510a); and
a locking ferrule (700, 700a) to be partially inserted into the rearward outer body (500, 500a), the locking ferrule (700, 700a) comprising a ridge configured for engagement with the corrugated outer conductor (125), and a foot portion (705, 705a) positionable within the recessed area (510, 510a) such that upon coupling of the rearward outer body (500, 500a) with the locking ferrule (700, 700a), the corrugated outer conductor (125) is locked in position.

2. The connector assembly of claim 1, wherein the ferrule comprises a plurality of annular ridges and wherein at least one of the plurality of annular ridges engages a valley of the corrugated outer conductor.

3. The connector assembly of claim 1, wherein the locking ferrule comprises a front ferrule end having an inwardly extending projection configured to engage with the post body.

4. The connector assembly of claim 1, wherein the locking ferrule comprises a plurality of slots that facilitate spring-like engagement with the corrugated outer conductor upon assembly with the rearward outer body.

5. A method of making a connector assembly (1000, 1000a) to be attached to a corrugated coaxial cable (100), the corrugated coaxial cable (100) comprising a center conductor (105), a dielectric (120) surrounding the center conductor (105), and a corrugated outer conductor (125) surrounding the dielectric (120), the method comprising:
forming a rearward outer body (500, 500a) to be received over a prepared end of the corrugated coaxial cable (100), wherein the rearward outer body (500, 500a) comprises a recessed area (510, 510a) defined therein;
forming a locking ferrule (700, 700a) to engage the rearward outer body (500, 500a), the locking ferrule (700, 700a) comprising a ridge configured for engagement with the corrugated outer conductor (125), and a foot portion (705, 705a) positionable within the recessed area (510, 510a);
coupling of the rearward outer body (500, 500a) with the locking ferrule (700, 700a); and
locking the corrugated outer conductor (125) in position.

6. A connector assembly (1000, 1000a) for attachment to a coaxial cable (100) with an outer conductor (125) having a peak (129) and a valley (127), said connector assembly comprising:
an outer body (500, 500a) for receiving the coaxial cable; and
a discrete ferrule (700, 700a) separate from said outer body, said ferrule having a base (709, 709a) and one or more elongated arms (720, 720a) extending outward from the base, each of said one or more elongated arms having an inward facing side with a ridge (710, 710a) configured to engage the valley to lock the coaxial cable (100) to the outer body (500, 500a).

7. The assembly of claim 6, wherein said ferrule comprises a c-shaped ring with a gap at the base, said c-shaped ring closing on the outer conductor to pinch the outer conductor between the gap.

8. The assembly of claim 6, said outer body having an inner surface with a recess, each of said one or more elongated arms having a foot portion with a lip projecting outward from an outer surface of each of said one or more elongated arms, said lip configured to be received at the recess.

9. The assembly of claim 8, said outer body having an inwardly-sloped inner surface, whereby said foot engages the inner surface of said outer body to bend each of said one or more elongated arms inwardly so that the ridge engages the cable valley and locks the ferrule to the cable.

10. The assembly of claim 8, said outer body having a step with a reduced diameter, whereby said foot engages the step to bend each of said one or more elongated arms inwardly so that the ridge engages the cable valley and locks the ferrule to the cable.

11. The assembly of any of claim 6, said outer body having a ramp configured to engage the base to reduce a diameter of the base to pinch the outer conductor.

12. The assembly of any of claim 6, said base having a front base surface, and further comprising a post body configured to engage said outer body, said post body having a rearward surface configured to mate with the front base surface of said ferrule to push the ferrule along a longitudinal axis of the assembly into the outer body as the outer body is further engaged with said post body.

13. The assembly of claim 12, wherein said post body has external threads and said outer body has internal threads that threadably engages the post body external threads

14. The assembly of claim 6, wherein the outer conductor has a first valley and a second valley, said discrete ferrule further having a widened foot configured to engage a first valley and said ridge configured to engage the second valley.

15. The assembly of claim 14, wherein said ridge and said foot have a same shape as the first and second valley.

16. The assembly of claim 14, said ferrule having a first bend line, whereby said ferrule bends at the first bend line to engage the ridge with the first valley.

17. The assembly of claim 16, said ferrule having a second bend line, whereby said ferrule bends at the second bend line to engage the foot with the second valley.

18. A connector assembly (1000, 1000a) for attachment to a coaxial cable (100) with an outer conductor (125) having a peak (129) and a valley (127), said connector assembly comprising:
an outer body (500, 500a) for receiving the coaxial cable (100) and having a compression mechanism (520, 520a); and
a ferrule (700, 700a) received in said outer body, said ferrule (700, 700a) having a base (709, 709a) forming an open ring with a gap, said compression mechanism (520, 520a) compressing said open ring to close on the outer conductor (125) under force applied by said compression mechanism to pinch the outer conductor at the gap (701).

19. The assembly of claim 18, said base having a recess configured to grip said outer conductor upon closing on the outer conductor.

20. The assembly of claim 18, said outer body comprising a back nut.
